(19) United States
(12) Patent Application Publication
(10) Pub. No.: US 2019/0138044 A1
(43) Pub. Date: May 9, 2019

(54) Control Stick Cap with Retention Features

(71) Applicant: Mark Slotta, Cary, NC (US)

(72) Inventor: Mark Slotta, Cary, NC (US)

(21) Appl. No.: 16/093,009

(22) PCT Filed: Apr. 12, 2017
(86) PCT No.: PCT/US2017/027183

§ 371 Date: Oct. 11, 2018

Related U.S. Application Data
(60) Provisional application No. 62/321,483, filed on Apr. 12, 2016.

(51) Int. Cl. G05G 1/06; G05G 9/047; G06F 3/0338

(52) U.S. Cl. CPC G05G 1/06; G06F 3/0338; G05G 9/047

(57) ABSTRACT

A control stick assembly includes a control stick with a body and an extension. The control stick assembly also includes a control stick cap with a recess. The recess includes a first portion and a second portion. A portion of the control stick body is located in the first portion of the recess. Further, the extension is located in the second portion of the recess. The control stick cap is not deformed by the control stick.

### CROSS-REFERENCE TO RELATED APPLICATIONS

This application claims the benefit of U.S. Provisional Application No. 62/321,483, filed Apr. 12, 2016, the disclosure of which is incorporated herein by reference.

### BACKGROUND OF THE INVENTION

This invention relates in general to a cap for a control stick. More specifically, this invention relates to a cap for a control stick with improved retention features.

Control sticks are often used as user input devices on laptop computers and other devices such as handheld controllers or fixed consoles. One common use for a control stick is as a mouse control device which is located in a central area on a laptop computer keyboard. Control sticks are typically made of plastic or other rigid material and have a limited range of movement. A user may place their finger on the control stick and employ the control stick as a directional input.

In many applications, the control stick includes a cap or cover. The cap is located between the control stick and the user's finger. The cap may provide a softer, more comfortable surface for the user, and may also provide a replaceable wear surface. The cap may also protect other elements from being damaged by the cursor control stick. For example, a screen of the laptop computer typically folds down onto the keyboard, and the cap may prevent the control stick from contacting the screen. Examples of such caps are described in, for example, U.S. Pat. No. 8,120,579, the disclosure of which is incorporated by reference.

The cap normally includes an opening on a lower surface into a recess in the cap. The cap is positioned with the control stick passing through the opening into the recess. It is typically desirable that the cap be retained on the control stick during normal use, but be removable when the user desires to replace the cap. In order to increase the force that retains the cap on the control stick, the cap may be made of an elastomeric material and the recess is made smaller than the control stick. As a result, when the cap is positioned on the control stick the cap is stretched out and grips the control stick. It would be desirable to have an improved way to retain the cap on the control stick.

### SUMMARY OF THE INVENTION

This invention relates to a control stick assembly. The control stick assembly includes a control stick with a body and an extension. The control stick assembly also includes a control stick cap with a recess. The recess includes a first portion and a second portion. A portion of the control stick body is located in the first portion of the recess. Further, the extension is located in the second portion of the recess. The control stick cap is not deformed by the control stick.

In some embodiments, the second portion of the recess is located farther from an opening in the control stick cap than the first portion of the recess. Also, the control stick enters the control stick cap through the opening. In some embodiments, walls of the recess are engaged with walls of the control stick. In some embodiments, the extension has an extension width and an extension height, and the second portion of the recess has a width that is the same size as the extension width and a height that is the same size as the extension height.

This invention also relates to a method of attaching a control stick cap to a control stick. The method includes inserting an extension of the control stick into a first portion of a recess of the control stick cap. The method also includes deforming the control stick cap from an original shape. The method includes moving the extension into a second portion of the recess. The method includes moving a portion of a body of the control stick into the first portion of the recess. The method also includes deforming the control stick cap to the original shape.

In some embodiments, the method also includes providing a control stick cap having the original shape.

Some embodiments of this invention relate to a method of attaching a control stick cap to a control stick. The method includes providing a control stick having a body and an extension. The extension defines a portion of the control stick which is wider than the body. The method includes providing a control stick cap having a recess with a first portion and a second portion. The first portion of the recess is connected to an opening on an outer surface of the control stick cap. The control stick cap has an original shape. The method includes inserting the extension of the control stick through the opening and into the first portion of the recess. The method includes deforming the control stick cap from the original shape. The method includes moving the extension on the control stick into the second portion of the recess. The method includes moving a portion of the body of the control stick into the first portion of the recess. The method also includes deforming the control stick cap to the original shape.

### BRIEF DESCRIPTION OF THE DRAWINGS

FIG. 1 is a perspective view of a laptop computer which includes a control stick with a control stick cap.

FIG. 2 is a side view of the control stick from the laptop computer.

FIG. 3 is a cross-sectional view of the control stick, taken along the line 3-3 of FIG. 2.

FIG. 4 is a perspective view of the control stick cap.

FIG. 5 is a bottom view of the control stick cap.

FIG. 6 is a cross-sectional view of the control stick cap, taken along the line 6-6 of FIG. 4.

FIG. 7 is an enlarged, detail view of a portion of the cross-section illustrated in FIG. 6.

FIG. 8 is a side view of a second control stick.

FIG. 9 is a cross-sectional view of the second control stick, taken along the line 9-9 of FIG. 8.

FIG. 10 is a perspective view of a second control stick cap.

FIG. 11 is a bottom view of the second control stick cap.

FIG. 12 is a cross-sectional view of the second control stick cap, taken along the line 12-12 of FIG. 10.

FIG. 13 is a cross-sectional view of a control stick assembly, which includes the control stick with the control stick cap attached thereto.

FIG. 14 is a cross-sectional view of a second control stick assembly, which includes the second control stick with the second control stick cap attached thereto.

### DETAILED DESCRIPTION OF THE PREFERRED EMBODIMENTS

Referring now to the drawings, there is illustrated in FIG. 1 a laptop computer, indicated generally at 10. The laptop computer includes a control stick assembly 11, which is mounted within a keyboard 14 on the laptop 10. The illustrated laptop 10 is one example of a device on which the control stick assembly 11 may be located. However, the control stick assembly 11 may be mounted on any desired type of device, such as handheld controller.

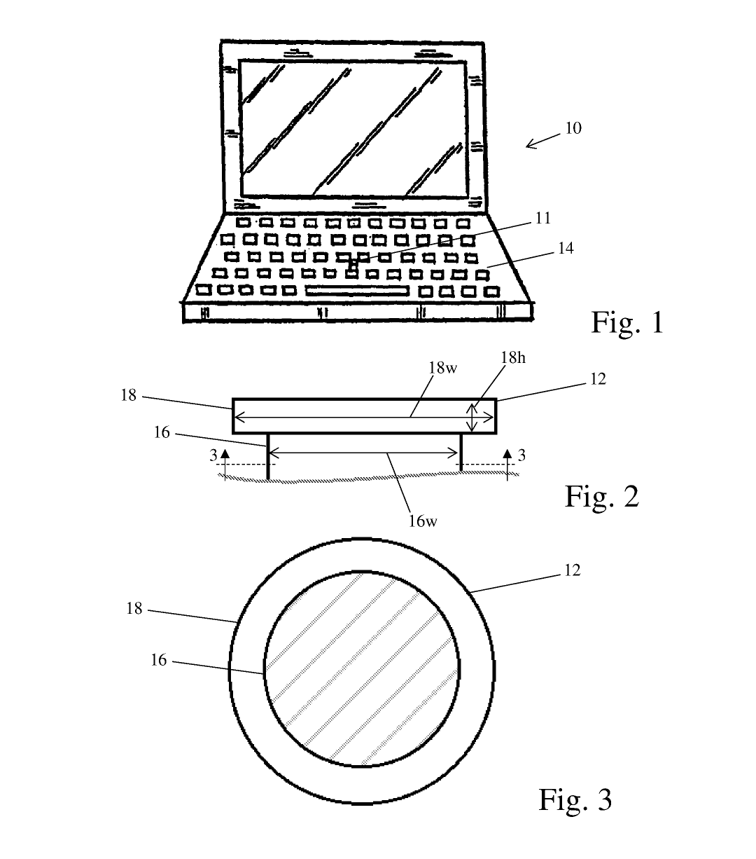

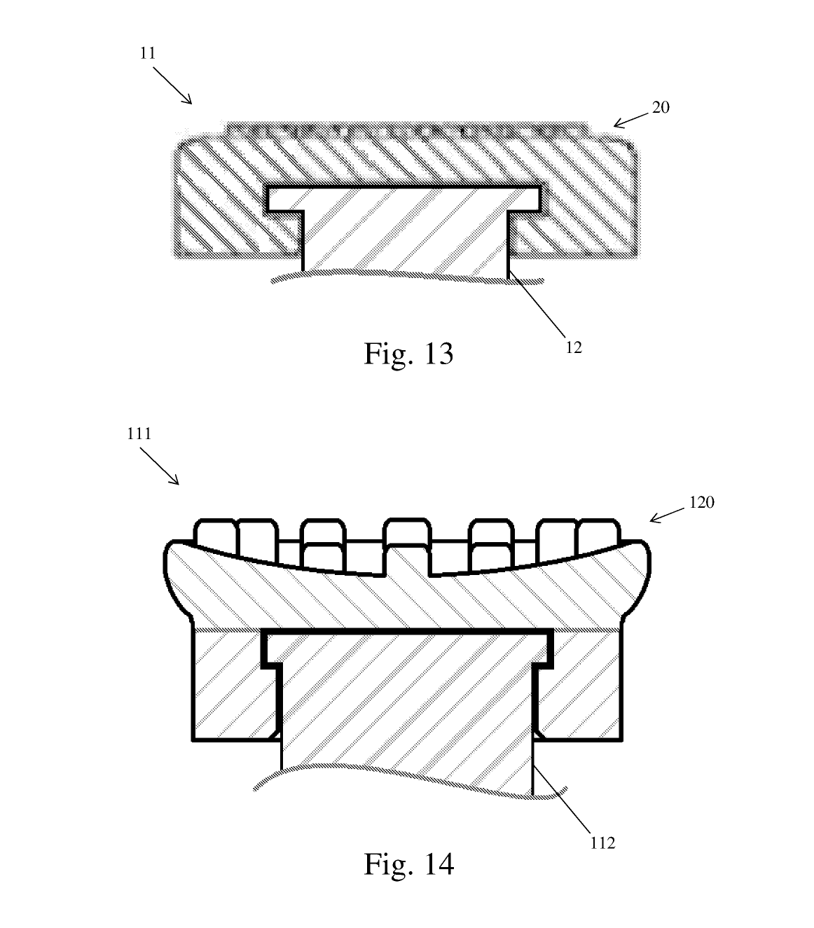

Referring to FIG. 13, there is shown a cross-sectional view of the control stick assembly 11. The control stick assembly 11 includes a control stick 12 and an attached control stick cap, indicated generally at 20. Referring to FIG. 2, there is shown a side view of the control stick 12. The illustrated control stick 12 is made of plastic, but may be made of any desired material. The control stick 12 includes a body 16 and an extension 18. The extension 18 extends beyond the outline of the body 16 and defines a portion of the control stick 12 which is wider than the body 16. Referring to FIG. 3, a cross-sectional view of the control stick 12 is shown taken along the line 3-3 of FIG. 2. As shown, both the body 16 and the extension 18 have circular cross-sectional shapes. However, the body 16 and the extension 18 may have any desired shapes.

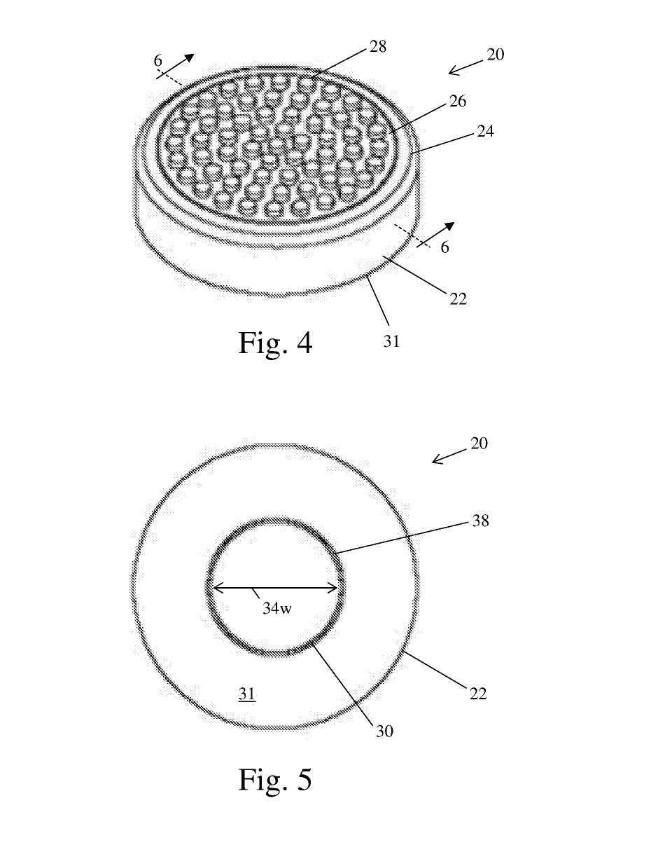

Referring now to FIG. 4, a perspective view of the control stick cap 20 is shown. The illustrated control stick cap 20 is made of an elastomeric material which is softer than the control stick 12. However, the control stick cap 20 may be made of any desired material. The control stick cap 20 includes a lower portion 22 and an attached upper portion 24. The illustrated lower portion 22 has a circular cross-sectional outer shape, but may have any desired outer shape. The illustrated upper portion 24 also has a circular cross-sectional outer shape, but may have any desired outer shape. The illustrated cursor control stick cap 20 is molded, but may be made by any desired method or technique. The upper portion 24 includes a contact surface 26, which is the portion of the control stick cap 20 which a user will contact with their finger during normal use of the control stick 12. The illustrated contact surface 26 includes a plurality of raise nubs 28 which provide a contact surface texture. However, the contact surface 26 may include any desired texture or treatment.

Referring now to FIG. 5, a bottom view of the control stick cap 20 is shown. The control stick cap 20 includes an opening 30 in an outer surface 31 of the lower portion 22. The illustrated opening 30 has a circular cross-sectional shape, which is the same shape as the control stick 20, but the opening 30 may have any desired shape. The illustrated opening 30 is concentric with the outer shape of the lower portion 22, but may have any desired relative position.

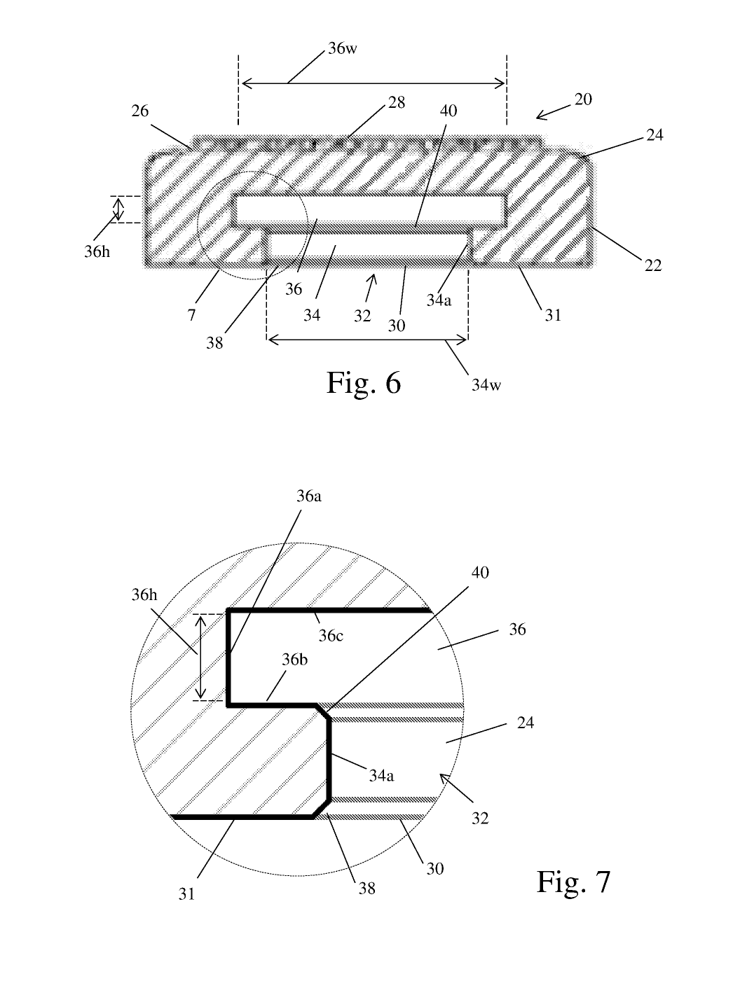

Referring now to FIG. 6, a cross-sectional view of the control stick cap 20 is shown, taken along the line 6-6 of FIG. 4. FIG. 7 shows an enlarged, detail view of a called-out portion of FIG. 6. The control stick cap 20 includes a recess, indicated generally at 32, defined therein. The opening 30 in the lower portion 22 of the control stick cap 20 provides access to the recess 32. The recess 32 includes a first portion 34 and a second portion 36. When the control stick cap 20 is installed on the control stick 12, the body 16 of the control stick 12 is located in the first portion 34 and the extension 18 of the control stick 12 is located in the second portion 36. Both the illustrated first portion 34 and the illustrated second portion 36 have circular cross-sectional shapes, but they may have any desired shapes.

The first portion 34 of the recess 32 includes a first outer wall 34a. Because the illustrated first portion 34 has a circular shape, there is a singular first outer wall 34a. The illustrated first outer wall 34a is generally perpendicular to the outer surface 31 of the control stick cap 20. The illustrated first portion 34 has a width 34w that is the same size as a body width 16w of the body 16 of the control stick 12 (shown in FIG. 2). The recess 32 includes a first transition 38 between the outer surface 31 and the first outer wall 34a. The illustrated first transition 38 is a straight wall segment which is sloped relative to the outer surface 31 and is sloped relative to the first outer wall 34a. The illustrated first transition 38 is sloped at approximately a 45 degree angle relative to the outer surface 31 and relative to the first outer wall 34a. However, the first transition 38 may have any desired shape.

The second portion 36 of the recess 32 includes a second outer wall 36a. Because the illustrated second portion 36 has a circular shape, there is a singular second outer wall 36a. The illustrated second outer wall 36a is generally perpendicular to the outer surface 31 of the control stick cap 20. The illustrated second portion 36 has a width 36w that is the same size as an extension width 18w of the extension 18 of the control stick 12 (shown in FIG. 2). The second portion 36 includes a lower wall 36b and an opposed upper wall 36c which are separated by a second portion height 36h. The second portion height 36h is the same size as an extension height 18h of the extension 18 of the control stick 12 (shown in FIG. 2).

The recess 32 includes a second transition 40 between the first outer wall 34a and the lower wall 36b. The illustrated second transition 40 is a straight wall segment which is sloped relative to the first outer wall 34a and is sloped relative to the lower wall 36b. The illustrated second transition 40 is sloped at approximately a 45 degree angle relative to the first outer wall 34a and relative to the lower wall 36b. However, the second transition 40 may have any desired shape.

In order to install the control stick cap 20 on the control stick 12, the extension 18 of the control stick 12 is inserted through the opening 30 in the control stick cap 20 and into the recess 32. As shown, the extension 18 is wider than the first portion 34 of the recess 32, and the control stick cap 20 is stretched and elastically deformed by the extension 18. The control stick cap 20 is moved relative to the control stick 12 so that the extension 18 enters the second portion 36 of the recess 32. As described, the second portion 36 is the same size as the extension 18, and control stick cap 20 is able to rebound to its original shape. At this point, the control stick cap 20 is installed on the control stick 12, the lower wall 36b and upper wall 36c engage opposed sides of the extension 18, and the outer wall 36a will engage an outer edge of the extension 18. In the illustrated embodiment, the second portion 36 is the same size as the extension 18 and the width 34w of the first portion 34 is the same size as the body width 16w of the body 16 of the control stick 12. As a result, when the control stick cap 20 is installed on control stick 12, the control stick cap 20 is not stressed, deflected, or deformed from its original shape. Additionally, the walls of the recess 32 are in contact with respective surfaces of the control stick 12.

The control stick cap 20 installed on the control stick 12 is illustrated in FIG. 13. Since the control stick cap 20 is not deformed when it is in its installed position on the control stick 12, the control stick cap 20 does not extend farther from the control stick 12 any further than its original shape would. This is advantageous in order to prevent the control stick cap 20 from interfering with the keyboard 14 or any other component of the laptop computer 10, or any other device the control stick assembly 11 is installed on. Additionally, by returning to its original shape, there is no pre stress force on the control stick cap 20 applied to bias the control stick cap 20 off of the control stick 12. Further, because the walls of the recess 32 are in contact with respective surfaces of the control stick 12, the control stick cap 20 is prevented from moving relative to the control stick 12. This is advantageous in that the control stick cap 20 is less likely to slip off the control stick 12. However, the recess 32 may have any desired internal dimensions.

Referring to FIG. 13, there is shown a cross-sectional view of a second control stick assembly 111. The second control stick assembly 111 includes a second control stick 112 and an attached second control stick cap, indicated generally at 120. The second control stick assembly 111 may be used in any application where the control stick assembly 111 may be used.

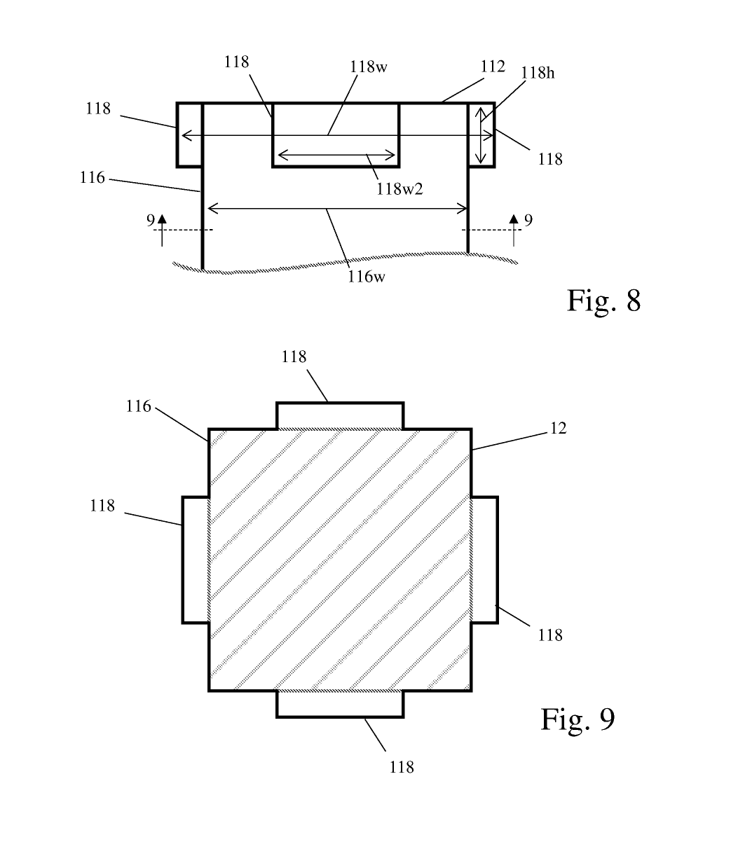

Referring to FIG. 8, there is shown a side view of the second control stick 112. The illustrated second control stick 112 is made of plastic, but may be made of any desired material. The second control stick 112 includes a body 116 and a plurality of extensions 118. The extensions 18 extend beyond the outline of the body 116 and define a portion of the second control stick 112 which is wider than the body 116. Referring to FIG. 9, a cross-sectional view of the second control stick 112 is shown taken along the line 9-9 of FIG. 8. As shown, the body 116 has a square cross-sectional shape. However, the body 116 may have any desired shaped. Also, the extensions 118 have rectangular cross-sectional shapes, and there is one extension 118 on each side of the body 116. However, extension 118 may have any desired shape and the second control stick 112 may have any desired number and placement of extensions 118.

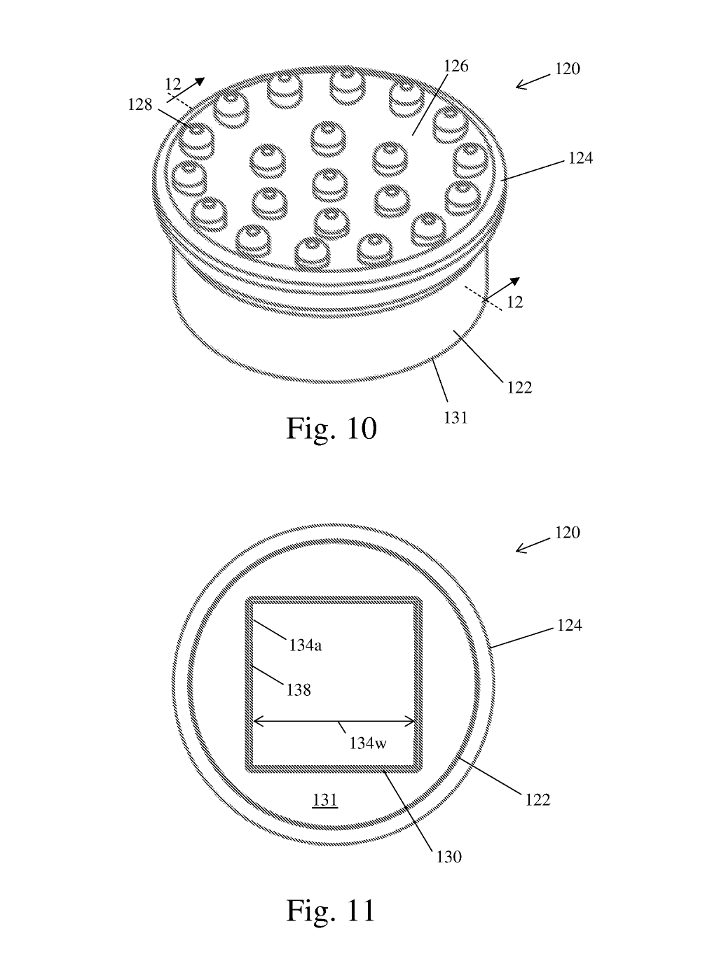

Referring now to FIG. 10, a perspective view of the second control stick cap 120 is shown. The illustrated second control stick cap 120 is made of an elastomeric material which is softer than the second control stick 112. However, the second control stick cap 120 may be made of any desired material. The second control stick cap 120 includes a lower portion 122 and an attached upper portion 124. The illustrated lower portion 122 has a circular cross-sectional outer shape, but may have any desired outer shape. The illustrated upper portion 124 also has a circular cross-sectional outer shape, but may have any desired outer shape. In the illustrated embodiment, the upper portion 124 has a larger diameter than the lower portion 122 and a part of the upper portion 124 overhangs the lower portion 122. However, the lower portion 122 and the upper portion 124 may have any desired relative sizes. The illustrated second cursor control stick cap 120 is molded in a two-shot process, but may be made by any desired method or technique. The upper portion 124 includes a contact surface 126, which is the portion of the second control stick cap 120 which the user will contact with their finger during normal use of the second control stick 112. The illustrated contact surface 126 has a concave shape, but may have any desired shape. The illustrated contact surface 126 includes a plurality of raise nubs 128 which provide a contact surface texture. However, the contact surface 126 may include any desired texture or treatment.

Referring now to FIG. 11, a bottom view of the second control stick cap 120 is shown. The second control stick cap 120 includes an opening 130 in an outer surface 131 of the lower portion 122. The illustrated opening 130 has a square cross-sectional shape, which is the same shape as the control stick 120, but the opening 130 may have any desired shape. The illustrated opening 130 is concentric with the outer shape of the lower portion 122, but may have any desired relative position.

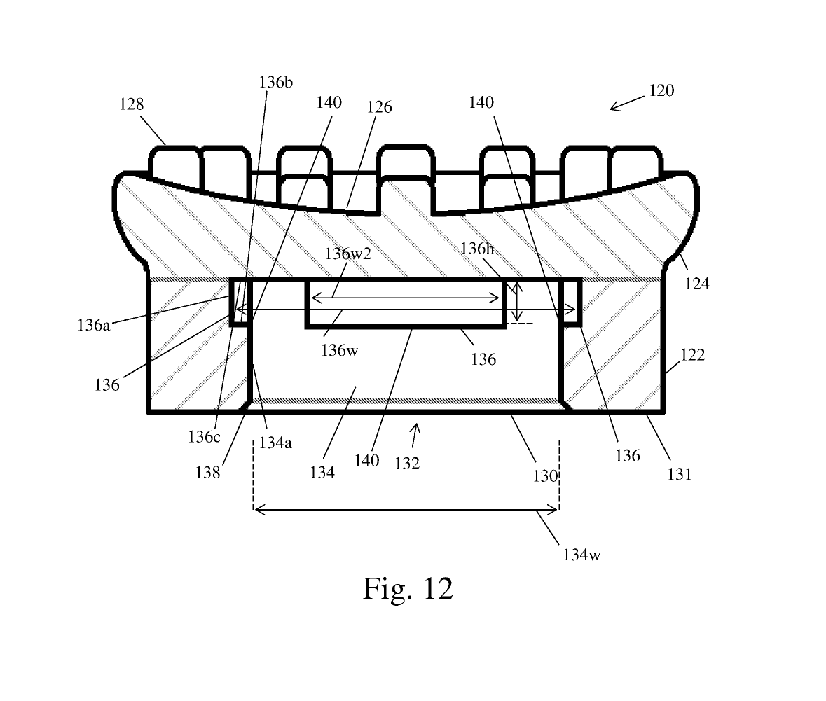

Referring now to FIG. 12, a cross-sectional view of the second control stick cap 120 is shown, taken along the line 12-12 of FIG. 10. The second control stick cap 120 includes a recess 132 defined therein. The opening 130 in the lower portion 122 of the second control stick cap 120 provides access to the recess 132. The recess 132 includes a first portion 134 and a plurality of recess extensions 136. When the second control stick cap 120 is installed on the second control stick 112, the body 116 of the second control stick 112 is located in the first portion 134 and the extensions 118 of the second control stick 112 are located in the recess extensions 136. The illustrated first portion 134 has a square cross-sectional shape, but may have any desired shape. The illustrated recess extensions 136 have rectangular cross-sectional shapes, but may have any desired shape. The illustrated second control stick cap includes four recess extensions 136 (three are visible in FIG. 12) to accommodate the four extensions 118 of the second control stick 112, but may include any desired number of recess extensions 136.

The first portion 134 of the recess 132 includes a plurality of first outer walls 134a. Each of the illustrated first outer walls 34a is generally perpendicular to the outer surface 131 of the second control stick cap 120. The illustrated first portion 134 has a width 134w that is the same size as a body width 116w of the body 116 of the second control stick 112 (shown in FIG. 8). The recess 132 includes a first transition 138 between the outer surface 131 and each of the first outer walls 134a. The illustrated first transition 138 is a straight wall segment which is sloped relative to the outer surface 131 and is sloped relative to the respective first outer wall 134a. The illustrated first transition 138 is sloped at approximately a 45 degree angle relative to the outer surface 131 and relative to the respective first outer wall 134a. However, the first transition 138 may have any desired shape.

Each of the recess extensions 136 includes a second outer wall 136a. Each of the illustrated second outer walls 136a is generally perpendicular to the outer surface 131 of the second control stick cap 120. Each recess extension 136 includes a lower wall 136b and an opposed upper wall 136c. When the second control stick cap 120 is installed on the second control stick 112, the lower wall 136b and upper wall 136c will engage opposed sides of the respective extension 118. Additionally, the outer wall 136a will engage an outer edge of the respective extension 118. The recess 132 includes a second transition 140 between the first outer wall 134a and the each of the lower walls 136b. The illustrated second transition 140 is a ninety degree angle corner with no radius and no chamfer. However, the second transition 40 may have any desired shape.

In order to install the second control stick cap 120 on the second control stick 112, the extensions 118 of the second control stick 112 are inserted through the opening 130 in the second control stick cap 120 and into the recess 132. As shown, the extensions 118 are wider than the first portion 134 of the recess 132, and the second control stick cap 120 is stretched and elastically deformed by the extensions 118. The second control stick cap 120 is moved relative to the second control stick 112 so that the extensions 118 enter the second portion 136 of the recess 132. The second portion 136 has dimensions 136h, 136w, and 136w2 (shown on FIG. 12) which are the same size as corresponding dimensions of the extension 118, 118h, 118w, and 118w2 (shown on FIG. 8). As a result, the second control stick cap 120 is able to rebound to its original shape. At this point, the second control stick cap 120 is installed on the second control stick 112 and the second control stick cap 120 is not stressed, deflected, or deformed from its original shape. Additionally, the walls of the recess 132 are in contact with respective surfaces of the second control stick 112. However, the recess 132 may have any desired internal dimensions.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A control stick assembly comprising:
a control stick including a body and an extension; and
a control stick cap including a recess with a first portion and a second portion, wherein a portion of the control stick body is located in the first portion of the recess and the extension is located in the second portion of the recess, wherein the control stick cap is not deformed by the control stick.

2. The control stick assembly of claim 1, wherein the second portion of the recess is located farther from an opening in the control stick cap than the first portion of the recess, and the control stick enters the control stick cap through the opening.

3. The control stick assembly of claim 2, wherein walls of the recess are engaged with walls of the control stick.

4. The control stick assembly of claim 1, wherein the extension has an extension width and an extension height, and the second portion of the recess has a width that is the same size as the extension width and a height that is the same size as the extension height.

5. A method of attaching a control stick cap to a control stick, the method comprising:
inserting an extension of the control stick into a first portion of a recess of the control stick cap;
deforming the control stick cap from an original shape;
moving the extension into a second portion of the recess;
moving a portion of a body of the control stick into the first portion of the recess; and
deforming the control stick cap to the original shape.

6. The method of attaching a control stick cap to a control stick of claim 5, further comprising, prior to inserting the extension of the control stick into the first portion of the recess of the control stick cap:
providing a control stick cap having the original shape.

7. A method of attaching a control stick cap to a control stick, the method comprising:
providing a control stick having a body and an extension, wherein the extension defines a portion of the control stick which is wider than the body;
providing a control stick cap having a recess with a first portion and a second portion, wherein the first portion of the recess is connected to an opening on an outer surface of the control stick cap, the control stick cap having an original shape;
inserting the extension of the control stick through the opening and into the first portion of the recess;
deforming the control stick cap from the original shape;
moving the extension on the control stick into the second portion of the recess;
moving a portion of the body of the control stick into the first portion of the recess; and
deforming the control stick cap to the original shape.

8. The method of attaching a control stick cap to a control stick of claim 7, wherein the step of deforming the control stick cap to the original shape is replaced with:
deforming the control stick cap to the original shape so that walls of the recess engage walls of the control stick.
